(19) United States
(12) Patent Application Publication
(10) Pub. No.: US 2015/0323787 A1
(43) Pub. Date: Nov. 12, 2015

(54) SYSTEM, METHOD AND COMPUTER-ACCESSIBLE MEDIUM FOR DEPTH OF FIELD IMAGING FOR THREE-DIMENSIONAL SENSING UTILIZING A SPATIAL LIGHT MODULATOR MICROSCOPE ARRANGEMENT

(71) Applicant: THE TRUSTEES OF COLUMBIA UNIVERSITY IN THE CITY OF NEW YORK, New York, NY (US)

(72) Inventors: RAFAEL YUSTE, New York, NY (US); SEAN ALBERT QUIRIN, New York, NY (US); DARCY S. PETERKA, Hoboken, NJ (US)

(21) Appl. No.: 14/763,010

(22) PCT Filed: Jan. 27, 2014
(86) PCT No.: PCT/US14/13180

§ 371 Date: Jul. 23, 2015

Related U.S. Application Data
(60) Provisional application No. 61/756,803, filed on Jan. 25, 2013.
(60) Provisional application No. 61/798,747, filed on Mar. 15, 2013.

(51) Int. Cl. G02B 27/00; G06K 9/00; G02B 21/36; G02B 21/00; G01N 21/64; G02B 21/06

(52) U.S. Cl. CPC G02B 27/0075; G01N 21/6458; G02B 21/06; G02B 21/365; G02B 21/0032; G06K 9/00134; G02B 21/367

(57) ABSTRACT

Spatial Light Modulator (SLM) microscopy can customize a sample illumination pattern from the microscope to simultaneously interrogate multiple targets localized within the sample. An exemplary SLM microscope arrangement can be used to image target locations at, e.g., arbitrary 3D coordinate by using, e.g., an extended Depth-of-Field computational imaging system. Multi-site three-dimensional targeting and sensing can be used in both transparent and scattering media. To that end, exemplary embodiments of system, method and computer-accessible medium can be provided for generating at least one image of at least one portion of a sample. For example, a computer hardware arrangement corn be provided. Such exemplary arrangement can be configured to receive information related to light, modified by the sample, after being previously manipulated by a optical addressing (e.g., diffraction) arrangement. Such exemplary computer hardware arrangement can also generate the image(s) based on the information.

### CROSS-REFERENCE TO RELATED APPLICATION(S)

The present application relates to and claim priority from U.S. patent application Ser. No. 61/756,803 filed on Jan. 25, 2013, and U.S. Patent Application Ser. No. 61/798,747 filed on Mar. 15, 2013, the entire disclosures of which are incorporated herein by reference.

### FIELD OF THE DISCLOSURE

The present disclosure relates generally to microscopy, and more specifically, to exemplary systems, methods and computer-accessible mediums for extended depth of field (“DOF”) imaging utilizing structured light illumination.

### BACKGROUND INFORMATION

Due to a growing variety of molecular probes, dynamic measurements of the functional characteristics from a localized environment in biological systems can be encoded into the temporal modulation of an optical signal. Examples can include fluorescence encoding of action potentials from neurons in calcium imaging (See, e.g., References 1 and 2), Ph sensitivity (See, e.g., Reference 3) and voltage sensitivity (See, e.g., Reference 4). However, common problems encountered with existing imaging and sensing methodologies can include a tendency for phototoxicity/photobleaching, insufficient temporal or spatial resolution, loss of signal when embedded in highly scattered materials, and a lack of high frame-rate three- dimensional imaging solutions.

An exemplary benchmark for optical system specifications within neuroscience can include the cortical column of neurons within a mouse cortex. The study of the cell-to-cell communication of networked neuron activity can benefit from fast, volume-based, data acquisition. The spatial domain specifications can include an imaging volume of ˜1 mm³, while maintaining the resolution that can be needed to resolve individual cell soma (e.g., ˜10 μm). The temporal domain specifications for resolving the calcium transients associated with action potentials can include volume-based data acquisition at greater than 30 Hz.

However, currently there does not exist an optical solution for this type of imaging, although numerous techniques have attempted to achieve an optical solution. (See, e.g., References 5, 6, 7, 8, 9, 10, 11, 12 and 13).

Thus, it may be beneficial to provide an exemplary optical system which can (i) reduce photo-exposure by using targeted illumination patterns, (ii) increase temporal resolution by decoupling the trade-off between temporal and spatial resolution, (iii) image in scattering media by using two-photon illumination, and (iv) provide simultaneous measurements of optical signals from many spatial locations throughout the sample , and which can overcome at least some of the problems described herein above.

### SUMMARY OF EXEMPLARY EMBODIMENTS

These and other objects of the present disclosure can be achieved by provision of exemplary systems, methods and computer-accessible for generating at least one image of a portion(s) of a sample.

To that end, it is possible to provided systems, methods and computer-accessible medium which can utilize Spatial Light Modulator (SLM) microscopy that can customize the sample illumination pattern from the microscope to simultaneously interrogate multiple targets localized within the sample. An exemplary SLM microscope arrangement can be used to image target locations at, e.g., arbitrary 3D coordinate by using, e.g., an extended Depth-of-Field computational imaging system. Multi-site three-dimensional targeting and sensing can be used in both transparent and scattering media.

According to an exemplary embodiment of the present disclosure, the system, method and computer-accessible medium can utilize, e.g., a computer hardware arrangement. With such exemplary arrangement, it is possible to receive information related to an electro-magnetic radiation(s) that can be modified by an optical addressing (e.g., diffraction) arrangement after being previously modified by portion(s) of the sample. At least one of the at least portion of the sample can be specifically targeted by at least one of a user or a computer instruction of the computer hardware arrangement by use of the optical addressing (e.g., diffraction) arrangement.

For example, an image(s) can be generated based on the information. The diffraction arrangement can be a wavefront modification device, and can be structured to modulate a phase or amplitude of the electro-magnetic radiation(s). The electro-magnetic radiation(s) can have a definitive three dimensional structure when an electro-magnetic radiation(s) is provided from the diffraction arrangement, and it can be non-ambient light. The image can be at least approximately axially invariant, substantially lossless, and can exclude defocus blur.

In some exemplary embodiments of the present disclosure, the electro-magnetic radiation(s) can have a shape of a sheet when the electro-magnetic radiation(s) intersects with a portion(s) of the sample. The electro-magnetic radiation can also have a shape of focused beams, or a shape that can conform to the shape of the portion(s) of the sample, when the electro-magnetic radiation is in the portion(s) of the sample. A spatial light modulation arrangement can generate the information using a three dimensional illumination pattern(s). According to certain exemplary embodiments of the present disclosure, a light source (e.g., a two-photon light source) can generate a source radiation that can be being provided to the sample, the source radiation can be related to the electro-magnetic radiation(s). The information can further relate to a further dynamically configurable diffraction arrangement that previously targeted the portion(s) of the sample.

In some exemplary embodiments of the present disclosure, a source arrangement can generate the light by illuminating the sample with an electro-magnetic radiation, which can be a non-linear excitation radiation. The illumination can be dynamic, temporally controlled and/or spatially controlled. The source arrangement can illuminate the sample based on a priori knowledge of the sample, which can include particular spots of the sample for the illumination or a number of spots on the sample for the illumination. The a priori knowledge can also be based on a previous illumination of the sample.

According to a further exemplary embodiment of the present disclosure, a system can be provided for generating an image(s) of a portion(s) of a sample, which can include a source arrangement, a spatial light modulation arrangement that can receive an electro-magnetic radiation(s) from the source and generate an illumination pattern on the sample. A wavefront modification arrangement can be provided that can receive a return radiation from the sample that can be based on the illumination pattern and can provide a further radiation. An imaging arrangement can be provided that can generate an image(s) based on further radiation received from the wavefront modification arrangement.

In some exemplary embodiments of the present disclosure, the sample can be biological. For example, the wavefront modification arrangement can control a depth of the return radiation. The wavefront modification arrangement can be fixed and non-movable within the system, and can be configured to increase information regarding a size of a volume of the sample. In certain exemplary embodiments, the performance by the imaging arrangement can be invariant. In some exemplary embodiments, a processing arrangement can be configured to digitally post process the image(s) to a near-optimal performance.

These and other objects, features and advantages of the exemplary embodiments of the present disclosure will become apparent upon reading the following detailed description of the exemplary embodiments of the present disclosure, when taken in conjunction with the appended drawings, and enclosed claims.

### BRIEF DESCRIPTION OF THE DRAWINGS

Further objects, features and advantages of the present disclosure will become apparent from the following detailed description taken in conjunction with the accompanying Figures showing illustrative embodiments, in which:

FIGS. 1A-1H are illustrations of exemplary phase profiles according to an exemplary embodiment of the present disclosure;

FIG. 2A is an illustration of an exemplary simulated pupil phase as a function of defocus for a conventional imaging microscope;

FIG. 2B is an illustration of an exemplary point spread function associated with FIG. 2A;

FIG. 2C is an illustration of an exemplary phase as a function of defocus for an extended depth of field microscope according to an exemplary embodiment of the present disclosure;

FIG. 2D is an illustration of an exemplary point spread function associated with FIG. 2C according to an exemplary embodiment of the present disclosure;

FIG. 3A is an illustration of an exemplary diagram of a joint spatial light modulation and extended depth of field imaging microscope for 3D targeting and monitoring according to an exemplary embodiment of the present disclosure;

FIG. 3B illustrates an exemplary phase aberration created with an exemplary diffractive optical element and placed in an accessible region according to an exemplary embodiment of the present disclosure;

FIGS. 4A-4C is an illustration of exemplary comparisons of exemplary focal plane images according to an exemplary embodiment of the present disclosure;

FIG. 4D is a graph illustrating exemplary fluctuations of fluorescence over time as measured by a restored image according to an exemplary embodiment of the present disclosure;

FIGS. 5A-5D are illustrations of exemplary results for an exemplary three-dimensional spatial light modulation in transparent media with a conventional and extended depth of field microscope according to an exemplary embodiment of the present disclosure;

FIGS. 6A-6D are illustrations of further exemplary results for the three-dimensional spatial light modulation in scattering media with both a conventional and extended depth of field microscope according to an exemplary embodiment of the present disclosure;

FIG. 7 is a set of illustrations of substeps/subprocedures of an exemplary defocus calibration procedure according to an exemplary embodiment of the present disclosure;

FIGS. 8A and 8B are illustrations of exemplary images of ideal transverse patterns of targets according to an exemplary embodiment of the present disclosure;

FIG. 9 is a set of illustrations of exemplary graphs indicating the axial dependence of a 3×3 affine transformation matrix as determined from imaging in a bulk slab of fluorescent material according to an exemplary embodiment of the present disclosure;

FIGS. 10A and 10B are exemplary graphs illustrating deconvolution results using a Wiener deconvolution filter and a Richardson-Lucy deconvolution according to an exemplary embodiment of the present disclosure;

FIG. 11 is an exemplary graph illustrating normalized fluorescence collected from an individual target according to an exemplary embodiment of the present disclosure; and

FIG. 12 is a block diagram of an exemplary system in accordance with certain exemplary embodiments of the present disclosure.

Throughout the drawings, the same reference numerals and characters, unless otherwise stated, are used to denote like features, elements, components, or portions of the illustrated embodiments. Moreover, while the present disclosure will now be described in detail with reference to the figures, it is done so in connection with the illustrative embodiments and is not limited by the particular embodiments illustrated in the figures and appended claims.

### DETAILED DESCRIPTION OF EXEMPLARY EMBODIMENTS

The exemplary embodiments of the present disclosure may be further understood with reference to the following description and the related appended drawings, but not limited thereby. The exemplary embodiments of the present disclosure relate to an exemplary system, method and computer-accessible medium for extended depth of field imaging utilizing spatial light modulation.

### Exemplary Spatial Light Modulator Microscopy for Three-dimensional Targeting Patterns

The devices, system and methods that use SLM microscopy, e.g., according to exemplary embodiments of the present disclosure can address and/or overcome certain limitations of the conventional microscopy systems, such as, e.g. (a) reduction of bulk photo-damage by specific illumination of only regions of interest; (b) true simultaneous targeting of multiple sites within the field of view; and (c) flexibility to create three-dimensional targeting patterns for use in a passive, imaging modality or an active photo-stimulation modality. Additionally, the use of SLM microscopy can accommodate both one-photon and two-photon illumination sources (see, e.g. References 13, 14 and 15)˜the latter of which is necessary for increasing the penetration depth in scattering media and improving axial resolution. (See, e.g. Reference 16).

SLM microscopy can simultaneously illuminate many targets and dynamically alter this targeting arrangement. Because the SLM can act as a field-programmable diffractive optical element, the illumination pattern from the microscope can be adjusted after separate computer algorithms recognize the experimental arrangement of targets. In addition, the SLM can accommodate to reflect the experimental realities present in the sample (e.g., variation in targeting density, aberration correction, temporal sequencing of targets, etc.). Previous work has demonstrated the importance of SLM microscopy to neuroscience where targets can include the dendrites from individual neuron cells (see, e.g. Reference 13) or the soma from large ensembles of neurons (see, e.g. Reference 15). Notably, this application in neuroscience can exploit the full flexibility afforded by the SLM in that it can also be used to deliver targeted light for photo-uncaging neurotransmitters or light-sensitive constructs like opsins to stimulate neuronal activity. (See, e.g. References 14, 13 and 17).

For targeted illumination, prism and lens phase can be applied to provide full three-dimensional control of the points within the object space. To create the SLM pattern illuminating point p̂ j=(x j , y j , z j ) where j is the index for each of N total targets, the phase can be loaded to the SLM in coordinate frame u1 , v1. To account for possible rotations, shifts and other forms of misalignment, a calibration can be included in Eq. 1 where the exact, position-dependent, transformations xc(p̂j ), yc(p̂j ), zc(p̂j ) can relate the coordinates of the SLM to the imaging detector. The axially-dependent phase component can be expanded into Zernike polynomials in order to offset the effects of higher-order spherical aberration (See, e.g. Reference 19).

$${H}_{j} ( {u}_{1} , {v}_{1} ; {\hat{p}}_{j} ) = \text{?} \\ \text{?} \text{indicates text missing or illegible when filed} \qquad Eq . 1$$

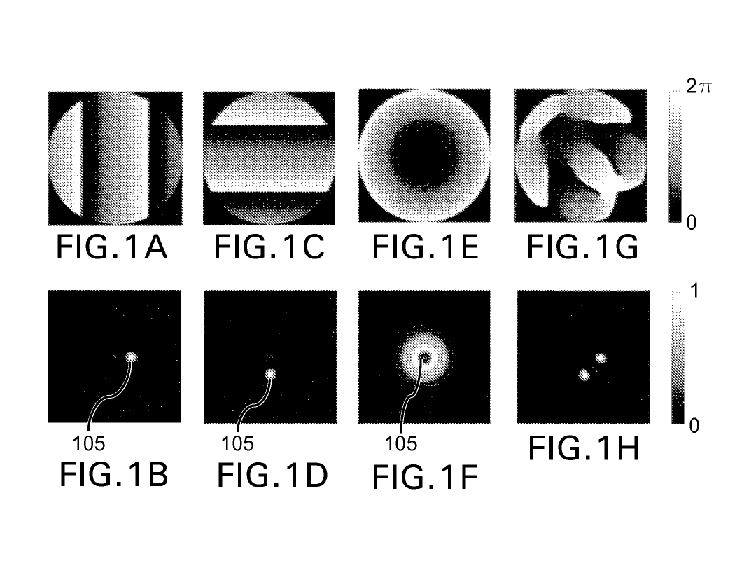

Exemplary details of this exemplary procedure, including definitions of the Zernike polynomials and their associated coefficients, are provided herein below. Examples of this exemplary phase pattern when this transformation is unitary can be seen in FIGS. 1A-1H for translation in x, y and z. Illuminations patterns for the ensemble of targets can be calculated using,

$${Θ}_{SLM} ( {u}_{1} , {v}_{1} ) = {\sum }_{j = 1}^{N} {H}_{j} ( {u}_{2} , {v}_{1} ; {\tilde{p}}_{j} ) \qquad Eq . 2$$

The exemplary intensity pattern near the focal plane of the objective can be found from,

$$i ( x , y ) = {\vert F \{ {Θ}_{SLM} \} \vert}^{2} \qquad Eq . 3$$

where F can be the Fourier transform operator.

In particular, FIGS. 1A-1H provide illustrations representative pupil phase profiles according to exemplary embodiments of the present disclosure. For example, FIG. 1A is an illustration for a horizontal translation, FIG. 1C is an illustration for a vertical translation, and FIG. 1E is an illustration of an axial translation with the associated Point Spread Functions of the focal plane shown in the simulations of FIGS. 1B, 1D and 1F, respectively. As shown in FIGS. 1B, 1D and 1F, the PSF of a pupil function with zero phase is illustrated (105) to emphasize the effect of the applied phase function. The phase function for the superposition of all three targets are shown in FIG. 1G and the associated image is illustrated in FIG. 1H. The defocused spot (shown in FIGS. 1E and 1F) can be dimmer because it can be located outside the image plane.

For SLM microscopy to monitor fluorescent activity simultaneously from multiple targets (e.g., as shown in FIG. 1H) can include the use of an imaging modality rather than the sensing modality using point detectors (e.g., Photo-multiplier Tubes, Avalanche photodiodes). As a result, the temporal resolution of the optical signal can be limited by the frame-rate of the camera, unlike point-scanning techniques which can be limited by a minimum dwell-time for collecting appreciable signal. For example, in the limit of this minimum dwell time, the exemplary systems, devices and methods which can utilize SLM microscopy can simultaneously image multiple targets to provide a distinct advantage over point-scanning. The availability of high-speed cameras with frame-rates up to, e.g., 1 kHz can set a temporary upper bound. However, further exemplary hardware can be provided to increase the frame rate.

Exemplary Extended Depth-of-Field Imaging using Engineered Point Spread Functions

An exemplary use of an imaging modality can simultaneously indicate that the sample being observed be planar (see, e.g. References 13 and 14), and thus may not be able to accommodate three-dimensional microscopy without the use of mechanical movement to sequentially scan the volume. (See, e.g. References 6, 7 and 8). Traditionally, this planar imaging condition can be characterized as having a limited DOF,

$$DOF ≡ \frac{2 n λ}{{NA}^{2}} , \qquad Eq . 4$$

where only a slice of this thickness through the object space volume can be sampled with high contrast using a conventional lens. Thus, the use of scanning beams with single pixel detectors can have greater freedom because it can collect signals from multiple axial planes. This can still effectuate and/or necessitate a sequential scanning of targets, and thus these conventional systems have not been demonstrated to monitor multiple points simultaneously. (See, e.g. References 9, 10, 11 and 12).

The exemplary system, method and computer-accessible medium can avoid such limitations by relying upon the joint optical-digital design techniques which can selectively enhance/suppress defocus-related performance through engineering of the optical Point Spread Function (“PSF”). (See, e.g., References 20, 21, 22, 23, 24 and 25). For the case of extending the imaging DOF, this opportunity can be gained by sacrificing the tightly-focused, symmetric spot traditionally chosen for high image contrast in favor of a highly aberrated PSF. For example, this aberrated PSF can overwhelm the aberration effects of defocus within some limited axial range. After the exemplary image acquisition with such a PSF, the use of digital image restoration techniques (e.g., deconvolution, see, e.g. exemplary description below) can be included and/or utilized for estimating the original object free of these fixed optical aberrations. With such exemplary systems and/or methods, the peak signal-to-noise ratio (SNR) of the in-focus image can be penalized relative to the classical imaging system, and can result in a smooth performance roll-off with respect to depth. This suppressed sensitivity to defocus thereby can facilitate multiple planes to be imaged simultaneously with similar fidelity. With the exemplary systems and/or methods according to exemplary embodiments of the present disclosure, the out-of-focus regions can be imaged with a higher SNR than conventionally available.

The Cubic-Phase (CP) mask can be selected from the family of suitable engineered PSF designs because it can be a phase-only modulating optical element (e.g., transparent), and can therefore maintain the full NA of the imaging system and can be associated with an optical Modulation-Transfer-Function (MTF) which may not contain zeros. (See, e.g. Reference 23). The result can be that all spatial-frequency content from the object can pass into the image; however, it can experience definite and known attenuation. The exemplary CP mask can be implemented by placing a phase modulation of,

$$p ( {u}_{2} , {v}_{2} ) = \text{?} \\ \text{?} \text{indicates text missing or illegible when filed} \qquad Eq . 5$$

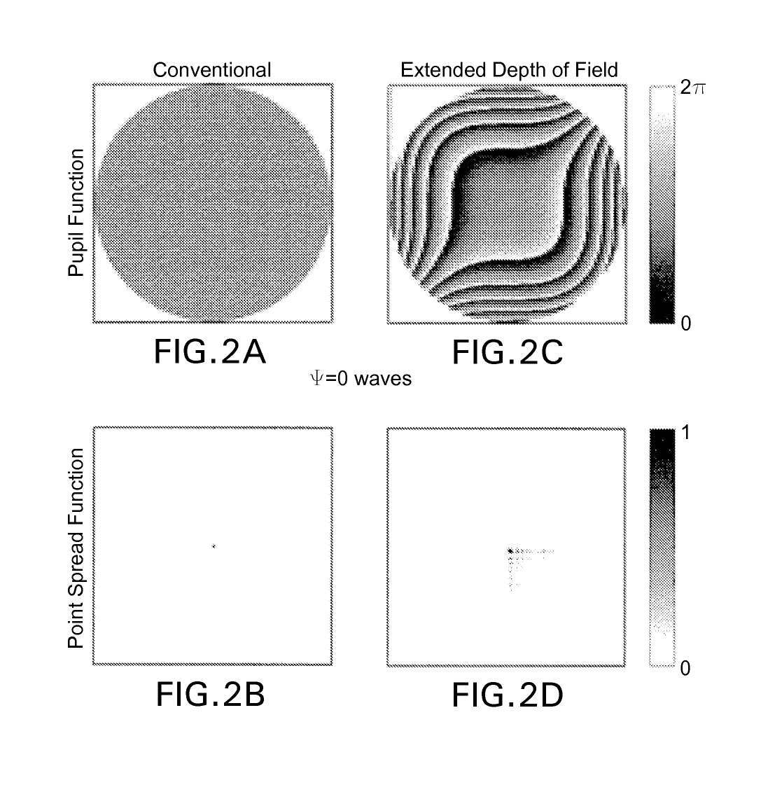

in the pupil plane of the imaging system, where u₂, v₂ can be the normalized transverse coordinates of the imaging pupil plane and a can be the coefficient determining the trade-off of depth of field extension versus image contrast (See, e.g. References 23 and 26). A simulated example to demonstrate the defocus stability of the CP PSF relative to the conventional PSF is shown in FIG. 2. Defocus can be parameterized here as, for example,

$$Ψ ( {u}_{2} , {v}_{2} ; dz ) = - \frac{1}{2 λ} ( {u}_{2}^{2} + {v}_{2}^{2} ) {NA}^{2} dz \qquad Eq . 6$$

where λ can be the wavelength for the optical signal, NA can be the numerical aperture of the objective and dz can be the axial dislocation relative to the focal plane and the scalar value max{Ψ(u₂, v₂;dz)} can be the number of waves of defocus present at the edge of the microscope pupil. An image taken as a function of object defocus is

$$i ( x , yz , dz ) = \vert F {\{ p ( {u}_{2} , {v}_{2} ) \text{?} \vert}^{2} \\ \text{?} \text{indicates text missing or illegible when filed} \qquad Eq . 7$$

In particular, FIGS. 2A-2D provide illustrations of a simulated pupil phase as a function of defocus for the conventional imaging microscope. Indeed, FIG. 2A shows the simulated pupil phase as a function of defocus for the conventional imaging microscope. FIG. 2B provides the pupil phase with the associated PSF. The representative pupil phase as a function of defocus for the extended DOF microscope is shown in FIG. 2C with an associated optical Point Spread Function (PSF) in FIG. 2D. As one example, the cubic phase coefficient, α, can be set to 30.

The transverse invariance of the CP PSF can come at the cost of a PSF which can translate as a function of axial position—a known trait of Airy beams. (See, e.g. Reference 27). One of the features of the SLM microscope arrangement according to an exemplary embodiment of the present disclosure can be that contrary to prior bright-field extended DOF techniques, such translation can be fully accounted for with the a prior information available from the SLM target locations.

### Exemplary Procedure

A joint SLM and extended DOF microscope arrangement is described herein below.

### Exemplary System Layout

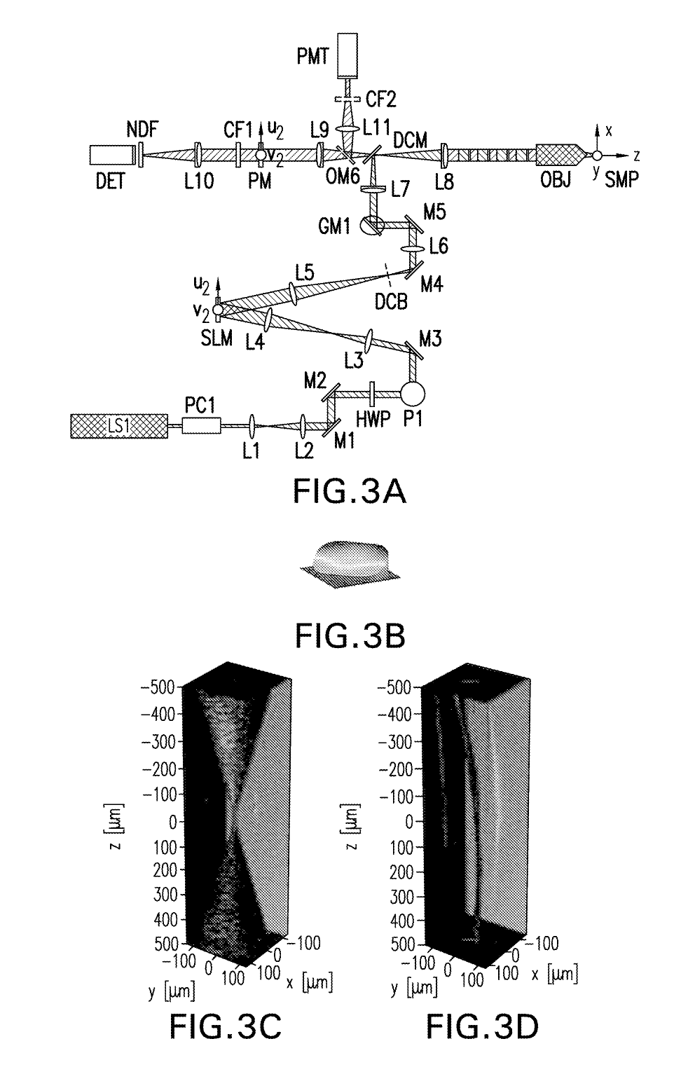

The optical system according to exemplary embodiments of the present disclosure can be provided as separate components/portions, e.g., (a) the illumination/targeting path; and (b) the imaging path. In one exemplary embodiment, both components/portions can share a common microscope objective, although that configuration is not necessary. This exemplary geometry can be advantageous because it can include only add-on units to the conventional microscope, and can satisfy biological in vivo and in vitro biological imaging constraints. FIG. 3A illustrates a schematic diagram of such exemplary configuration of a joint SLM and extended-DOF imaging microscope arrangement for 3D targeting and monitoring according to an exemplary embodiment of the present disclosure.

For example, as shown in FIG. 3A, the exemplary components used by such exemplary arrangement (which are also fully described below) can be as follows:
LS1—light source
PC1—Pockel's cell
L1 and L2—singlet lenses forming a telescope
M1 and M2—di-electric coated EO3 mirrors
HWP—half-wave plate retarder
P1—Periscopic mirror set
L3 and L4—singlet lenses forming a telescope
SLM—Spatial Light Modulator located f4 behind L4
L5 and L6—singlet lenses forming a reducing telescope
DCB—DC signal beam block for the non-modulated SLM signal
GM1—galvo-scanning mirrors
L7—Scanning lens
DCM—Dichroic mirror which can reflect λ>about 700 nm
L8—tube lens
OBJ—Water-immersion microscope objective (10×/0.3 NA)
L9 and L10—achromatic doublet lenses forming a 1:1 relay of the intermediate image
PM—cubic-phase mask
CF1—chromatic filter
NDF—short-pass filter
DET—EM-CCD detector

A point-scanning modality can be facilitated by, e.g., mounting M3 and M4 on flip mounts to bypass the SLM and using GM1 to scan the sample. In this exemplary configuration, the fluorescence emission may also be collected by the Photo-multiplier tube (PMT) by inserting an optional mirror OM6 in a beam path. The lens L11 can collect the fluorescence emission, and converge it onto the PMT after passing through a chromatic filter (CF2).

As shown in the exemplary embodiment of the system according to the present disclosure that is illustrated in FIG. 3A, the illumination path can begin with the two-photon light source (LS1: Coherent Chameleon Ultra), and can pass through a Pockel's cell (PC1: Conoptics, Model 350-160) for independent control of the illumination intensity; followed by a telescope (L1:f1=50 mm, L2:f2=150 mm), and can be redirected up a periscope (P1) and through another telescope (L3:f3=50 mm, L4:f4=100 mm), which can result in a total exemplary increase of the beam size by approximately 6×, before illuminating the SLM (SLM: Holoeye, HEO1080p). An iris can be placed in front of the SLM so that the beam size may not be able to illuminate in-active regions of the SLM back-plane. The SLM can be de-magnified by approximately 2.5× with the preceding telescope (L5:f5=250 mm, L6:f6=100 mm) before being projected onto a pair of X/Y galvo scanning mirrors (GM1). These galvo mirrors can center the beam through the scanning lens (L7:f7=50 mm) of an Olympus BX-51 microscope, which can then be reflected off a dichroic mirror (DCM: Chroma NIR-XR-RPC, reflects @ 700-1100 nm) into the tube lens (L8:f8=180 mm) and towards the microscope objective (OBJ: Olympus UMPLFLN 10×/0.3 NA). Here, the use of a low NA objective can demonstrate an exemplary maximum useable axial extent of imaging the object space.

For example, the imaging path can use the objective OBJ to image the optical signal from the targets in the sample SMP to the intermediate image plane located after the tube lens (L8) towards the camera (DET: Andor iXon Ultra2) using, e.g., a 1:1 imaging relay (L9 and L10, f9=f10=150 mm). The utility of the relay can be to re-image the microscope pupil into an accessible location where it can be manipulated independently from the illumination pupil. The CP phase mask (PM) can be place one focal length behind L9 and one focal length in front of L10 along with a color filter (CF1: Chroma, 510/40 M). A neutral density filter (NDF: Chroma, HQ700SP-2P8 of OD6 @ λ<=600 nm) can be placed in front of the detector to reject scattered and reflected light from the laser source.

Exemplary Design and/or Manufacture of Phase Mask Arrangement

The design of the exemplary CP phase mask for the SLM microscope arrangement, according to an exemplary embodiment of the present disclosure, can include a determination of a suitable coefficient a to match the axial range of the illumination pattern. Because a SLM procedure(s) can be used to generate the defocus targeting range, in practice, it can remain the particular device before the defocus phase leads to aliasing (See, e.g. Reference 28). For example, these exemplary constraints can facilitate a maximum defocus of z₁₌8.5 mm before aliasing contributes to unwanted signal.

The exemplary CP phase mask can be configured or structured to work with one or both a high NA objective and a low NA objective. An exemplary choice of coefficient α=200 (e.g., in a normalized coordinate system) with a phase mask diameter =18 mm can be determined by, e.g., a simulation of the system and approximately matching the desired performance. The phase mask can be designed to accommodate a large number of objective designs (e.g., Olympus, XLUMPLFL 20×/0.95 WNA, =17.1 mm, XLPLAN N 25×/1.05 WNA, =15.1 mm). For the purposes of reporting values most relevant to the microscope objective used here (Olympus UMPLFLN 10×/0.3 NA, as reported earlier), an equivalent phase mask can be provided with a =10.8 mm and α≈43.

An exemplary 8-level phase mask can be manufactured into a quartz substrate (e.g., Chemglass Life Sciences, CGQ-0600-01) using, e.g., conventional, multi-level lithographic techniques (Swanson). A laser mask writer (Heidelberg μPG 101) with 3 μm feature size can be used to provide each of the three binary chrome masks (Nanofilm, SL.HRC.10M.1518.5K) preferrable to generate 8-level diffractive optics. The first chrome mask can be loaded into a mask-aligner (Suss MicroTec MA6) to transfer the pattern into the photoresist (Shipley 1818 positive resist) spun onto a blank quartz substrate. After developing the photoresist, a dry-etch (Oxford PlasmaLab 80 Plus ICP65) can be used to selectively remove the quartz substrate while leaving the quartz protected under the photoresist safe. The photoresist can then be stripped and uniformly re-applied to the quartz substrate and the process repeated for binary chrome masks 2 and 3.

### Exemplary Calibration

To quantify the chromaticity of the liquid crystal SLM and the effects of optical mis-alignment in the illumination path, it is possible to estimate the orientation and axis of the pupil plane/SLM relative to the imaging detector.

For example, to optimize SLM procedure operation at λ=760 nm (e.g., to create a look-up table optimized to resolve a 2π phase stroke), calibration of applied voltage versus relative phase delay for the pixels in the SLM can be performed by loading a Ronchi grating and varying the modulation depth. (See, e.g. Reference 30). Thereafter, centering of the SLM pattern to the optical axis can be accomplished by, e.g., scanning a grating across the SLM in orthogonal directions and selecting the locations with peak diffraction intensity into the 1st order. These searches can gradually reduce in transverse scan length until a precise estimate of the optical axis, relative to the SLM, can be made.

For exemplary SLM pupil plane to object space calibration, the axial distance can be calibrated and corrected experimentally (e.g., see Appendix I for details and comparison with theoretical results). Then, the appropriate affine transform matrix (e.g., the characterization of the transverse dimension) can be estimated at varying depths by projected a 2D array of points into object space. As a result of these exemplary calibration procedures, the imaging 3D PSF can be sampled for both the conventional optical imaging system and the extended DOF optical system according to an exemplary embodiment of the present disclosure by, e.g., illuminating a single point into bulk fluorescent material and shifting this point axially using the exemplary SLM as shown in FIGS. 3C and 3D, respectively.

Indeed, FIG. 3B provides an illustration of an image providing a phase aberration which can be treated with a diffractive optical element, (DOE) according to an exemplary embodiment of the present disclosure. The phase aberration shown FIG. 3B can be provided with a diffractive optical element, and placed in an accessible region between L9 and L10 without affecting the illumination pupil. FIG. 3C shows an exemplary image generated by an exemplary optical Point Spread Function (PSF) presented for the conventional microscope.

### Exemplary Results

Exemplary results for the case of three-dimensional targeting and imaging in transparent and scattering media are provided herein below.

### Exemplary Three Dimensional Targeting and Imaging for Monitoring Fluorescence in Transparent Samples

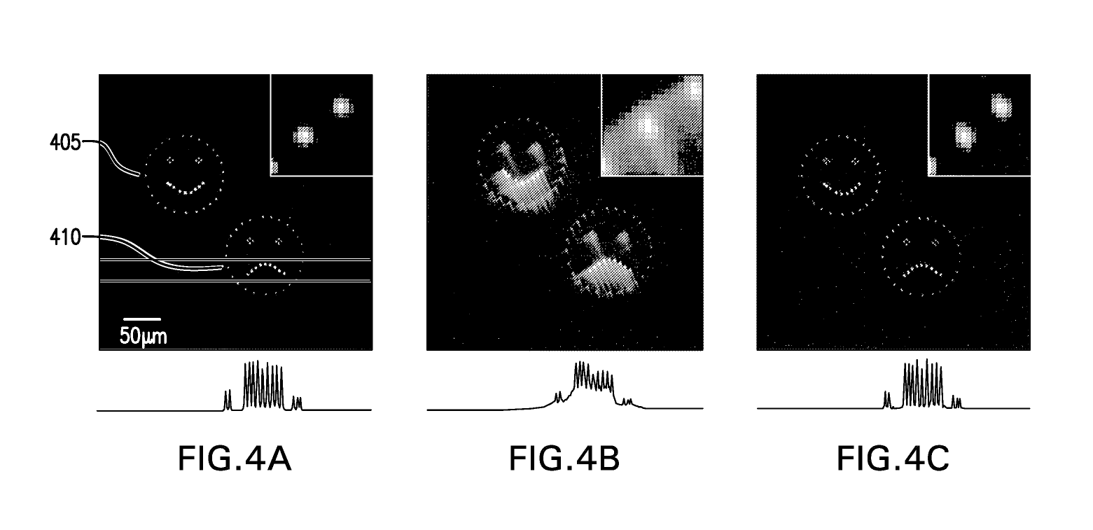

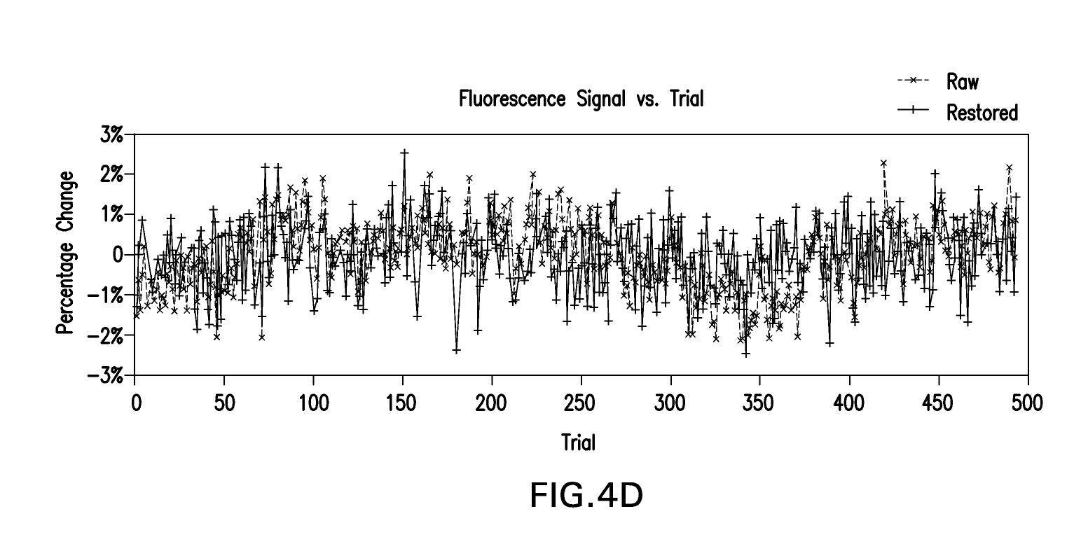

The exemplary system capabilities can be seen by illuminating a sample made of an agarose mixture (e.g., 3.5 grams of 1% agarose by weight in double-distilled deionized H₂O) with fluorescent dye (e.g., 3.5 grams of double-distilled deionized water loaded with yellow dye from a Sharpie Highlighter pen). A three-dimensional illumination pattern can be projected 620 μm below the cover-slip/agarose interface. The illumination pattern can consist of two large features constructed from an ensemble of point targets. The north-west feature can be the happy-face 405, and the south-east feature can be the unhappy-face 410, of exemplary images generated by a conventional microscope, as shown in FIG. 4A. With the exemplary CP mask placed in the optical imaging path, the image can be aberrated with a raw extended DOF image, as shown in FIG. 4B. Using image restoration techniques discussed in Appendix II below, this raw and intermediate, aberrated, image can be processed to return an estimate of the target (See, e.g., FIG. 4C), which can rival the conventional image in quality. Here, the contrast of each image can be enhanced to aid in visual interpretation using 0.1% saturation. A demonstration of the effect that the image restoration techniques can have on the fluorescence can be seen in FIG. 4D. Two exemplary time series of the fluorescence signal from a single target can be provided. One can be the raw signal 420 from the extended DOF system, and the other can be the restored 415, extended DOF, image. It can be shown that the temporal fluctuations of the fluorescence signal from a stable source imaged with the exemplary extended DOF system can behave similarly before and after image processing.

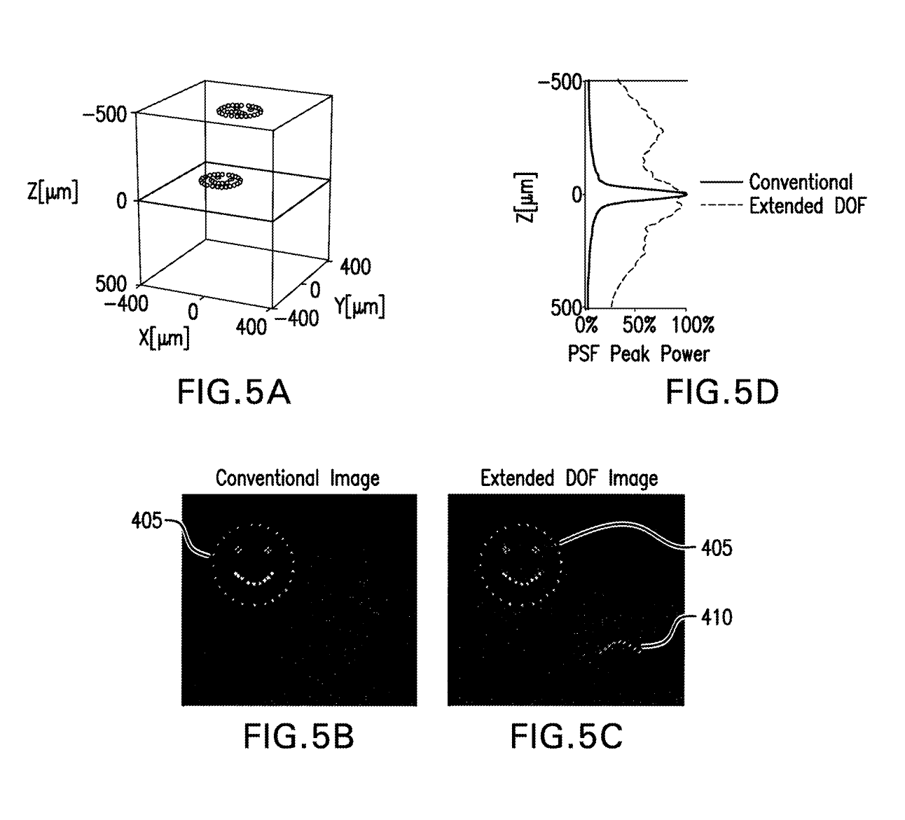

To demonstrate the exemplary three-dimensional capabilities of the exemplary system, method and computer-accessible medium according to an exemplary embodiment of the present disclosure, the south-east feature 410 can be translated axially −500 μm≦z≦+500 μm from the classical focal plane (defined as dz=0) in 4 μm intervals while the north-west feature 405 can be held fixed in the focal plane, FIG. 5A, which can show a three-dimensional illumination pattern. The exemplary imaging, which can result from a conventional imaging microscope, can be presented in FIG. 5B. In conventional imaging-based microscopy techniques, a rapid loss of imaging performance can occur as the illumination can translate beyond the focal plane. In contrast, the restored image from the exemplary system, method, and computer-accessible medium, which can utilize an extended DOF microscope, can be seen in FIG. 5C, which can illustrate a relative increase in the out-of-focus signal, and tightly localized points regardless of axial location. This increase can be quantified in FIG. 5D, and can include the loss of illumination intensity as the target spot can be shifted from the focal plane. In addition, for example, with the application of an axially-dependent pre-calibration, the projected pattern can maintain the same magnification throughout the volume scanned.

Such exemplary results can indicate that targets within the SLM addressable three-dimensional volume can be imaged to localized regions on the camera, somewhat independently of the axial position. Since the PSF can essentially be axially invariant, the monitored optical signal can be obtained by, e.g., searching for the associated peak in the restored image and summing the counts in a localized region. For example, ignoring constraints imposed by SLM characteristics and light source power, the maximum number of spatially multiplexed targets can then be limited only to the restored image cutoff spatial frequency (e.g., the spot size of the restored target) which itself can be a function of the image noise. The optical signal collected from the spatially multiplexed targets can be taken and/or employed simultaneously, e.g., regardless of three-dimensional location—a distinguishing feature of the exemplary system, method and computer-accessible medium.

### Exemplary Three-dimensional Targeting and Imaging for Monitoring Fluorescence in Scattering Samples

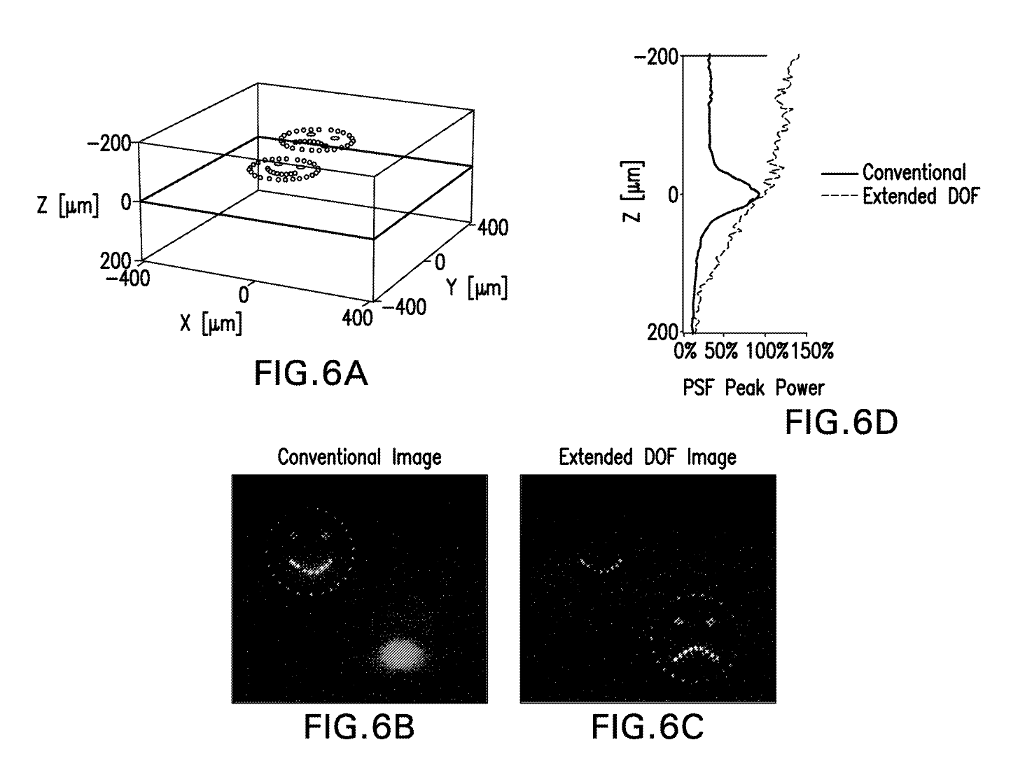

A problem frequently encountered in biology can be that the sample can be embedded in highly scattering tissue, where the scattering can reduce the illumination intensity exponentially with depth. Conventional microscopy systems can suffer from a reduced operational range that can be expected for three-dimensional targeting and imaging. The results for three-dimensional targeting and imaging can be seen in FIGS. 6A-C. The exemplary three-dimensional illumination pattern is shown in FIG. 6A, and the relative intensity of the fluorescence as a function of depth is illustrated in FIG. 6DThe results from imaging the three-dimensional pattern in bulk fluorescent material can be shown for a conventional microscope in the exemplary image of FIG. 6B, and the extended DOF microscope in the exemplary image of FIG. 6C. Contrast can be enhanced, and can remain the same, as shown in FIGS. 6B and 6C.

As the target can be located deeper in the scattering medium, the collected fluorescence can decrease rapidly. However, despite the presence of scattering in the imaging path, the deconvolution can result in useable information. For example, the useable depth has increased for shallow axial positions with the extended DOF module, however going deeper the signal can be dominated by scatter and approaches the same relative losses as the conventional microscope.

### Further Exemplary Embodiments

An exemplary three-dimensional imaging microscope according to an exemplary embodiment of the present disclosure that is described herein can be built upon, e.g., the foundation of two exemplary independent optical techniques. First, e.g., the illumination can be spatially and/or temporally structured using a modulating device (e.g., the Spatial Light Modulator) such that emission from the sample can be limited to known regions in 3D and time prior to detection or sensing. Second, e.g., the optical signal emitted from the illuminated regions can be collected using an optically efficient imaging system, which can produce images of near-equivalent quality regardless of the source emission position in the sample volume (e.g., extended Depth of Field). The three-dimensional illumination can use a solution for efficiently acquiring an optical signal from anywhere within the sample volume. Similarly, the exemplary system, method and computer-accessible medium can use a solution for disambiguating the sources of emission such that signal can be assigned to specific locations within the sample volume. The joint implementation of these complementary techniques can create a much more flexible solution. The prior knowledge provided by the user-controlled illumination device can be beneficial in facilitating a context to the images acquired by the extended Depth of Field microscope. While an exemplary demonstration can include a SLM as the source of the structured illumination, other methods for projecting patterns, such as light-sheet microscopy, can be equally suited for this improvement by, e.g., coupling with the extended Depth of Field microscope.

The exemplary 3D targeting and imaging procedures, methods, arrangements, systems and computer-accessible medium according to certain exemplary embodiments of the present disclosure described herein can indicate that the exemplary methods and/or procedures for working with transparent media can be more reliable than with scattering media. However, it should be emphasized that the scattering example can be worst case—a situation where the fluorescence contrast between the target and background can be, e.g., 1:1. In exemplary applications where targets can be specifically labeled with dyes or the use of genetic encoding, the ratio of fluorescence in the target to that of the background will become much more favorable.

As shown in FIGS. 6A-6C, and in FIG. 13, a significant difference between imaging in scattering vs. transparent media can be the loss of signal with depth. Eventually, this signal loss can lead to a condition where targets at multiple scattering lengths within the media become difficult to image. To aid with this issue, a weighted Gershberg-Saxon (wGS) procedure/algorithm can be useful for compensating this axial-dependence with a corresponding axial-dependent increase in the target illumination intensity. For example, wGS procedures/algorithms can be demonstrated for use in applications such as optical trapping and would have an immediate impact here on extending the maximum imaging depth.

As imaging can be pushed further into the media, the size of the imaged spot for each target can grow correspondingly large. Because the deconvolution discussed herein has assumed an axial-independence, this variability can lead to reconstruction errors. It is likely that the axial-dependent spot size using the a priori knowledge of where the target can be located and potentially compensate using an exemplary spatially-variant deconvolution method/procedure. In addition, as the spot size increasingly grows with depth a problem with the spatial overlap of neighboring targets can be anticipated. A direct exemplary solution for this would include temporal multiplexing the target illumination patterns such that the overlap can be minimized. However, this can be a trade-off between the maximum imaging depth and the temporal resolution of the optical signal.

The exemplary system, method, and computer-accessible medium according to the exemplary embodiments of the present disclosure can be used as optical platforms becomes fixed. For example, brain tissue slices can be frequently created with a 300 μm thickness. This can place a limit on the necessary extension of the DOF and therefore an optimum combination of a microscope objective with a phase mask can be designed. For example, according to one exemplary embodiment, the exemplary phase mask design (e.g., cubic-phase mask with α=200 for a =18 mm pupil diameter) can be selected to generally operate with a wide variety of sample and microscope objective combinations. An exemplary optimum combination can provide that the transverse size of the extended DOF PSF may be limited, likely resulting in, e.g., a higher image contrast for the particular DOF. Another exemplary modification can be that of a phase mask for high NA objectives.

Further exemplary alternative phase mask implementations can be provided for extended DOF. Examples can include the super-position of multiple Fresnel zone plates (See, e.g. Reference 21), Bessel-beams (See, e.g. Reference 20), and other families of propagation-invariant beams (See, e.g. Reference 31). It is possible that for specific tasks (e.g., point targeting versus extended object targeting), another exemplary solution can be provided.

In addition, exemplary improvements in image processing techniques can be provided for increasing the fidelity of the restored signal. One example can be with iterative deconvolution techniques where prior information can be applied. For example, the Richardson-Lucy deconvolution algorithm/procedure can be or include a procedure which can enforce and/or facilitate constraints on the signal based upon a priori information preferring the signal to be positive. This a priori information can yield further improvements by including the known illumination patterns (e.g., the target can be a point). In addition, additional modifications for and/or on exemplary deconvolution techniques in the presence of scattering materials can be beneficial to the exemplary devices using engineered PSF optical technology.

### Exemplary Conclusion

According to an exemplary embodiment of the present disclosure, an exemplary system, method and computer-accessible medium can be provide that can be, e.g., free from some or any mechanical motion to create a three-dimensional targeting pattern and three-dimensional images of the optical signal. The exemplary system, method, and computer-accessible medium can utilize independent modulation of the transverse phase of the optical beam on both the illumination and imaging side of the microscope. The exemplary system, method and computer-accessible medium can be amenable to fast imaging, and may not be restricted to illuminating or imaging the sample in a sequential planar pattern. An exemplary microscope can be tested and performance can be verified in both transparent and scattering media. Because it can consist of only “bolt-on” modules to existing microscopes, the exemplary system, method, and computer-accessible medium can be used for in vivo imaging. Therefore the exemplary system, method and computer-accessible medium is unique in providing vibration-free equipment for biological research in a package which does not need a massive redesign of existing microscopes.

### Exemplary Illumination/Targeting Pattern Calibration Procedure

The exemplary procedures for calibrating the projection of the phase-encoded SLM onto the sample volume and imaging detector according to exemplary embodiments of the present disclosure are described below. These exemplary procedures can be valuable for accommodating optical misalignment and maintaining stable performance over time.

### Exemplary Calibration of Axial Translation

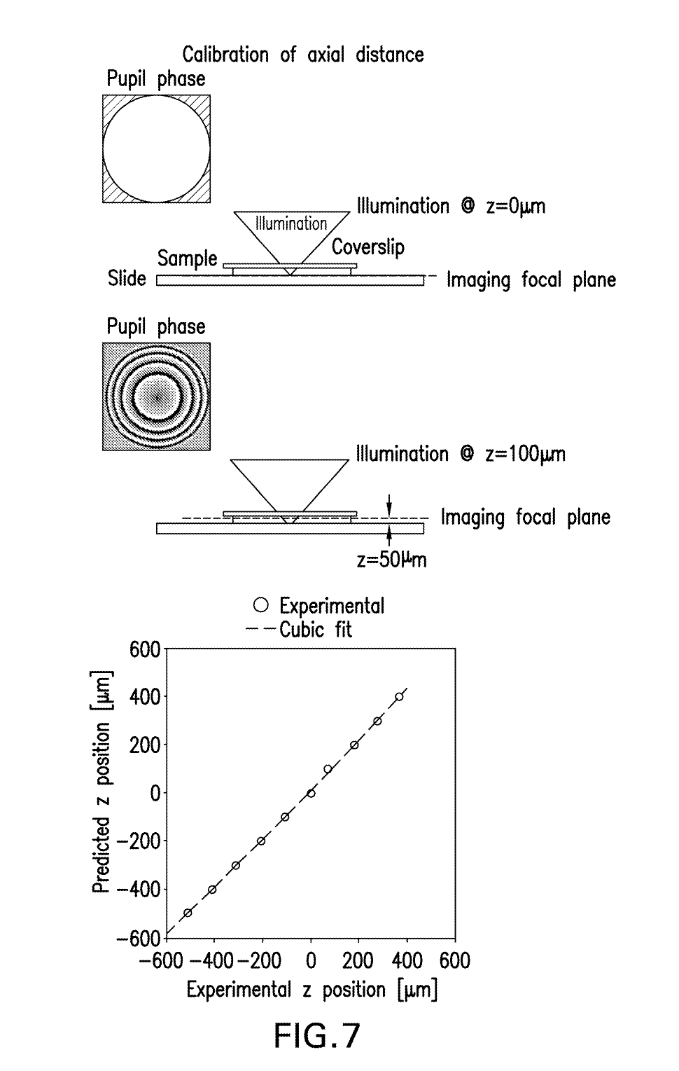

The axial distances can be calibrated through a procedure where the reflection from a moveable di-electric interface can be actively focused after applying a variable amount of defocus phase to the SLM. The exemplary optical configuration and associated illustrations are shown in FIG. 7, which can show that in the exemplary defocus calibration method, the back-reflection from the sample/slide interface can be in focus on the imaging path. When zero defocus phase can be applied at the SLM (e.g., the pupil plane), the in-focus image can be at the focal plane. A defocus phase can be applied at the SLM to translate the target illumination in 100 μm intervals. For each defocus phase on the SLM, the sample stage can be translated axially until the back -reflection can be focused using the imaging path. The sample translation can be recorded as the experimental z position for each expected z position. The theoretical curve predicts distances which can be on average 3.2% larger than the experimentally determined axial position.

In particular, as an initial matter, a defocus phase can be placed on the SLM which should provide a target at (x,y)=(0,0) in plane z using, for example:

$$H ( {u}_{1} , {v}_{1} : 0 , 0 , z ) = \text{?} \\ \text{?} \text{indicates text missing or illegible when filed} \qquad Eq . 8$$

Where the coefficient and Zemake modes are listed in Table 1 and

$$\text{?} = \sqrt{{u}_{1}^{2} + {v}_{1}^{2}} . \text{?}$$

$$\text{?} \text{indicates text missing or illegible when filed}$$

TABLE I [symbol] [symbol]
and associated coeddicients for aberration compensation

| Aberration | Coefficient | Polynomial |
|---|---|---|
| Defocus | $\text{?} \frac{0}{\text{?}} ( z ) - \frac{\text{?}}{\text{?}} \text{?} 1 \text{?} \frac{1}{\text{?}} {sin}^{2} α \text{?} \frac{\text{?}}{\text{?}} {sin}^{2} α \text{?} \frac{1}{16} {sin}^{6} α \vert$ | Z [symbol] (ρ) = \sqrt{3} \|2ρ² − 1\| |
| Spherical- [symbol] order | $\text{?} \frac{0}{\text{?}} ( z ) - \frac{\text{?}}{\text{?}} \vert 1 \text{?} \frac{\text{?}}{4} {sin}^{2} α \text{?} \frac{15}{18} {sin}^{4} α \vert$ | Z [symbol] (ρ) = \sqrt{5} \|6 [symbol] − 6ρ² − [symbol] \| |
| Spherical- [symbol] order | $\text{?} \text{?} ( z ) - \frac{\text{?}}{\text{?}} \vert 1 \text{?} \frac{5}{4} {sin}^{2} α \vert$ | Z [symbol] (ρ) = \sqrt{7} \|20ρ² − 30ρ⁴ − 12ρ² − 1 [symbol] |

[symbol]

indicates data missing or illegible when filed

This expansion of the defocusing aberration into higher-order Zernike polynomials can be included for both three-dimensional imaging as well as imaging in biological tissue with refractive index mismatches (See, e.g. References 19, 32 and 13). Using this exemplary form for defocus aberration, the theoretical curve can be in agreement with the exemplary measurements shown in FIG. 7. For an improved accuracy, a fit of the experimental curve can be taken as zc(z)=az3+bz2+cz+d to be used for calibration of the experimental axial distance where the coefficients are found to be a=2.8e−8, b=7.0e−5, c=1.032, and d=12.08.

### Exemplary Calibration of Transverse Coordinates

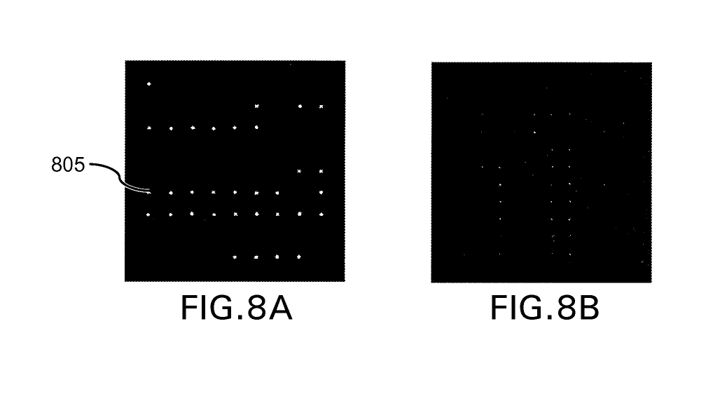

A second exemplary calibration can be performed for estimating the transverse position of the targeting pattern relative to its expected position on the imaging detector. Sources of these deviations can be due to SLM rotation relative to the camera, misalignment of optical components along the optical axis as well as the oblique incidence angle of the optical beam to the SLM. In this sense, the calibration step can remove any rotation, shear or other transformation which can be considered affine. For the transverse pattern calibration, a target pattern can be projected (as shown in FIGS. 8A and 8B) and the affine transformation can be calculated from the experimental measurement relative to the ideal position. For the transverse pattern calibration, a target pattern 805 can be projected, for example as seen in FIG. 8A, and the affine transformation can be calculated from the experimental measurement relative to the ideal position. An asymmetric pattern can allow for unambiguous calibration of the affine transform in the exemplary experimental image of FIG. 8B.

For example, using the expected coordinate positions x, y and the experimental positions x′ and y′ for this target pattern the transform can be defined as, for example,

$$[ \begin{matrix}{m}_{11} ( {z}^{′} ) & {m}_{12} ( {z}^{′} ) & {m}_{13} ( {z}^{′} ) \\ {m}_{21} ( {z}^{′} ) & {m}_{22} ( {z}^{′} ) & {m}_{23} ( {z}^{′} ) \\ {m}_{31} ( {z}^{′} ) & {m}_{32} ( {z}^{′} ) & {m}_{33} ( {z}^{′} )\end{matrix} ] [ \begin{matrix}x \\ y \\ z\end{matrix} ] = [ \begin{matrix}{x}^{′} \\ {y}^{′} \\ {z}^{′}\end{matrix} ] \qquad Eq . 9$$

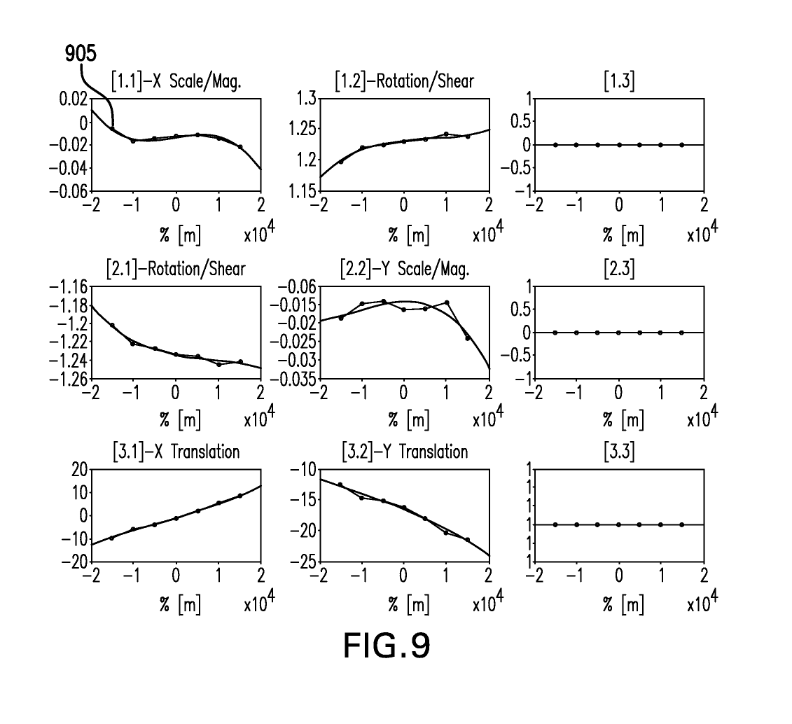

Because optical misalignment can lead to depth-variant aberrations, this transverse coordinate transformation can be defined to be a function of the target depth z. In exemplary embodiments, a minimum of seven axial planes can be used to calibrate the axial dependence of this affine transform matrix, and each coefficient of the matrix can be fit to a curve 905, as shown in FIG. 9, to provide a smoothly varying affine transform at any continuous axial position. For example, FIG. 9 provides a set of graphs illustrating an axial dependence of a 3×3 affine transformation matrix as determined from imaging in a bulk slab of fluorescent material, according to the exemplary embodiment of the present disclosure.

Using both the axial and transverse calibration, the completely calibrated target illumination for the SLM display can be found as, for example:

$${H}_{j} ( {u}_{1} , {v}_{1} ; {\hat{p}}_{j} ) = \text{?} \\ \text{?} \text{indicates text missing or illegible when filed} \qquad Eq . 10$$

### Exemplary Image Restoration Methods/Procedures and Associated Signal Stability

The exemplary signal restoration utilized for this exemplary technique can include that the deconvolution provide a stable estimation of the original signal. To verify that the extended DOF imaging system can provides such exemplary results, certain exemplary alternative restoration techniques can be used.

As an initial matter, e.g., Wiener deconvolution can be selected as this can a linear, least-squares solution which can provide a non-iterative restoration. The Wiener deconvolution can be defined as, for example:

$$\text{?} \\ \text{?} \text{indicates text missing or illegible when filed} \qquad Eq . 11$$

Where psf_{EDOF} can be the PSF, i_{EDOF} can be the experimental image, SNR can be the spatial frequency SNR and ô(x, y) can be the restored signal. It can be seen from Eq. 9 that this can include a priori information of the PSF and the spatial frequency SNR. In practice, the PSF can either be found experimentally or an ideal, simulated PSF can be used. The SNR can be calculated or otherwise determined empirically or estimated to provide the best or most appropriate restoration.

An alternative exemplary algorithm/procedure can be used, which can utilize the Richardson-Lucy (RL) iterative procedure (MatLab Image Processing Toolbox, The Mathworks, Natick, Mass.), where the i+1 iteration estimate can be found from, for example,

$$\text{?} \\ \text{?} \text{indicates text missing or illegible when filed} \qquad Eq . 12$$

Again, a priori information can be beneficial in the form of the PSF as well as the optimum number of iterations.

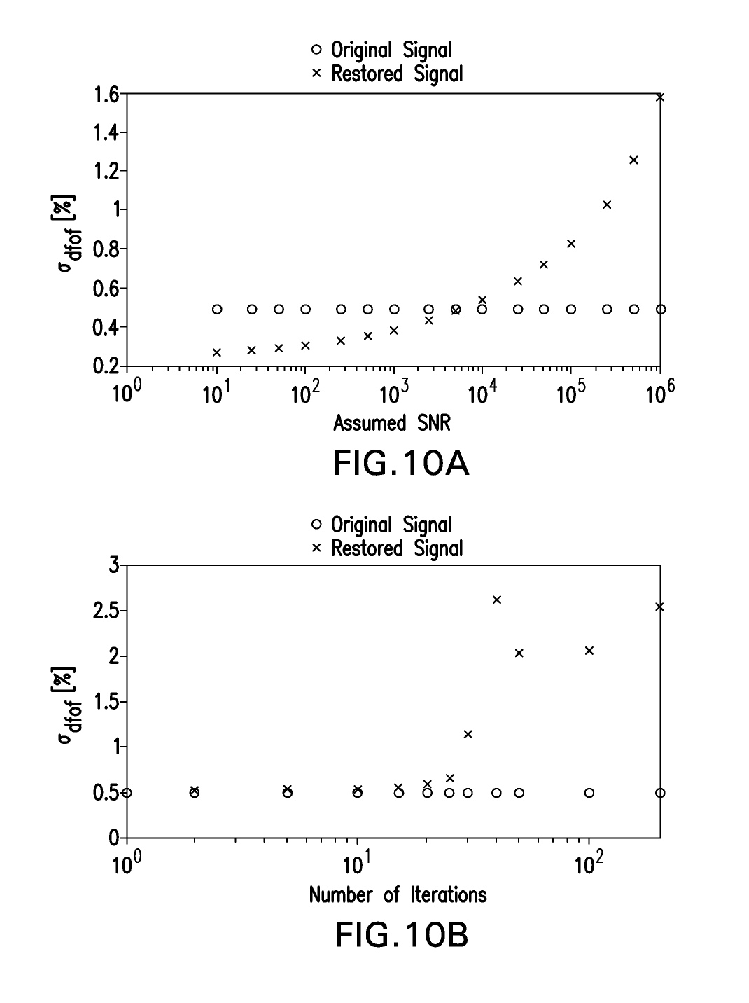

To quantify the performance of each exemplary deconvolution algorithm/procedure with respect to each free variable (spatial frequency SNR for Wiener, interation number for RL), a time series of fluorescence from a single, in-focus target was recorded using the extended DOF imaging system. This exemplary image series can be deconvolved using an experimentally measured psf_{EDOF} which was recorded from the same sample. The standard deviation of the percentage change of the signal, can be defined as, for example,

$$Δ f - \frac{O - \overline{O}}{\overline{O}} \qquad Eq . 13$$

where o can be the mean signal that can be plotted with respect to the relevant free variables, as shown in the exemplary graphs of FIGS. 10A and 10B. For example, errors in estimating the spatial frequency SNR for the Wiener deconvolution can smoothly adjust the gain on the restored signal, and scale the restored signal. An optimum SNR may not recreate the exact signal fluctuation; however the SNR from multiple targets in an image may not be expected to remain static. Therefore, it may not be assumed that the optimum SNR for every individual target can be used during the restoration procedure.

For example, the results shown in the top graph of FIG. 10 have been generated using the Wiener deconvolution filter, and the bottom graph using Richardson-Lucy deconvolution. The exemplary results in the top graph indicate that, e.g., an optimum or preferred SNR can be selected to match the restored image relative variation in fluorescent signal fluctuation. Either a lower or higher guess of the SNR will yield a lower or higher estimate of the relative fluctuation. The exemplary results shown in the bottom graph of FIG. 10 can indicate that less iteration will yield a more stable estimate of the restored signal's true variability.

For the exemplary RL procedure, the signal may not be smoothly restored as the number of iterations increases. For low numbers of iterations, the exemplary solution can be under-corrected until an optimum can be found, and then over-corrections can lead to variable success for restoration.

For example, as shown in the graphs of FIGS. 10A and 10B, the exemplary deconvolution results can be provided using an exemplary Wiener deconvolution filter (see,

FIG. 10A) and Richardson-Lucy deconvolution (see FIG. 10B). The exemplary graph of FIG. 10A can indicate that an optimum SNR can be chosen in order to match the restored image relative variation in fluorescent signal fluctuation. Either a lower or higher guess of the SNR can yield a lower or higher estimate of the relative fluctuation. The exemplary graph of FIG. 10B indicates that less iterations can yield a more stable estimate of the restored signal's true variability

### Exemplary Scattering Properties of Phantom Samples

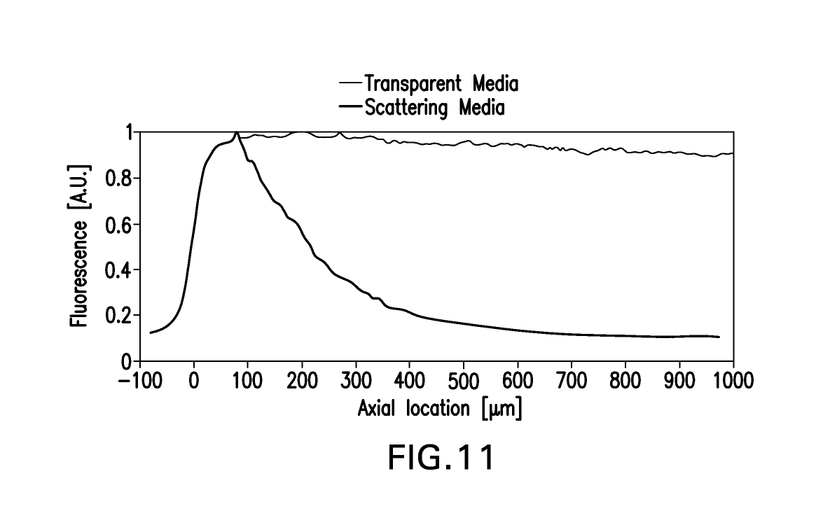

The exemplary scattering phantom can include, e.g., 3.5 grams of the fluorescent dye solution (50% by weight), 0.5 grams of whole, pasteurized milk (7% by weight) and 3.0 grams of the 1% agarose mixture (43% by weight). Total losses from the illumination and imaging for both the transparent and the scattering sample can be seen in a the graph of FIG. 11. Indeed, FIG. 11 shows a graph of the normalized fluorescence collected from an individual target as the sample can be translated axially using the device, system and method according to an exemplary embodiment of the present disclosure. For example, the axial translation of the sample can be performed so that the sample depth can be increased. At large depths, a slight decrease in the collected signal can be observed for the transparent sample while the scattering sample experiences near extinction of the signal by, e.g., about 500 μm.

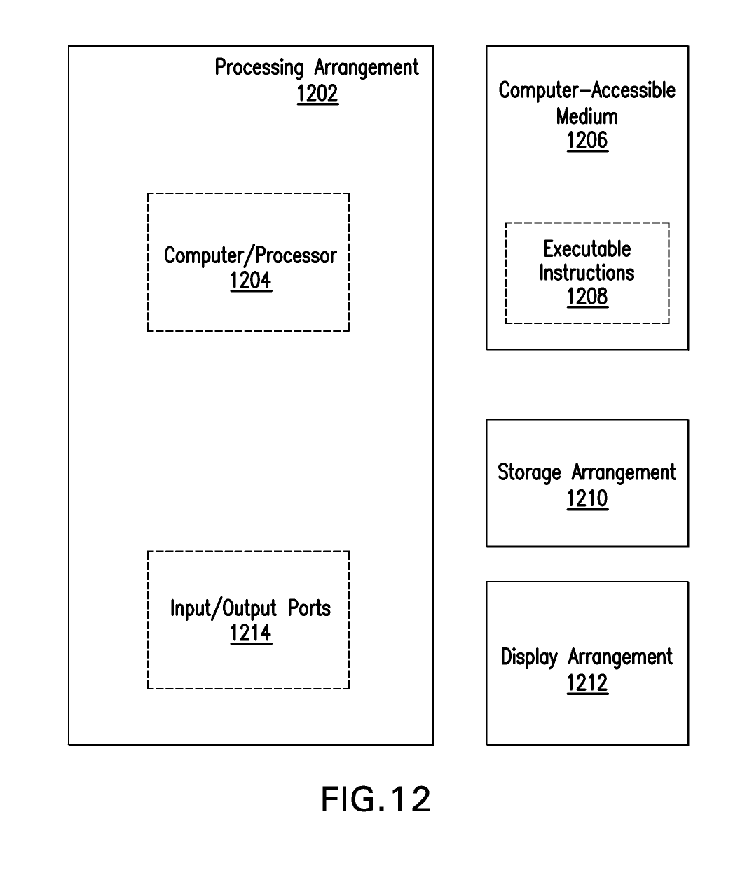

FIG. 12 shows a block diagram of an exemplary embodiment of a system according to the present disclosure. For example, exemplary procedures in accordance with the present disclosure described herein can be performed by a processing arrangement and/or a computing arrangement 1202. Such processing/computing arrangement 1202 can be, e.g., entirely or a part of, or include, but not limited to, a computer/processor 1204 that can include, e.g., one or more microprocessors, and use instructions stored on a computer-accessible medium (e.g., RAM, ROM, hard drive, or other storage device).

As shown in FIG. 12, e.g., a computer-accessible medium 1206 (e.g., as described herein above, a storage device such as a hard disk, floppy disk, memory stick, CD-ROM, RAM, ROM, etc., or a collection thereof) can be provided (e.g., in communication with the processing arrangement 1202). The computer-accessible medium 1206 can contain executable instructions 1208 thereon. In addition or alternatively, a storage arrangement 1210 can be provided separately from the computer-accessible medium 1206, which can provide the instructions to the processing arrangement 1202 so as to configure the processing arrangement to execute certain exemplary procedures, processes and methods, as described herein above, for example.

Further, the exemplary processing arrangement 1202 can be provided with or include an input/output arrangement 1214, which can include, e.g., a wired network, a wireless network, the internet, an intranet, a data collection probe, a sensor, etc. As shown in FIG. 12, the exemplary processing arrangement 1202 can be in communication with an exemplary display arrangement 1212, which, according to certain exemplary embodiments of the present disclosure, can be a touch-screen configured for inputting information to the processing arrangement in addition to outputting information from the processing arrangement, for example. Further, the exemplary display 1212 and/or a storage arrangement 1210 can be used to display and/or store data in a user-accessible format and/or user-readable format.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures which, although not explicitly shown or described herein, embody the principles of the disclosure and can be thus within the spirit and scope of the disclosure. Various different exemplary embodiments can be used together with one another, as well as interchangeably therewith, as should be understood by those having ordinary skill in the art. In addition, certain terms used in the present disclosure, including the specification, drawings and claims thereof, can be used synonymously in certain instances, including, but not limited to, e.g., data and information. It should be understood that, while these words, and/or other words that can be synonymous to one another, can be used synonymously herein, that there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

### EXEMPLARY REFERENCES

The following references are hereby incorporated by reference in their entireties:
[1] R. Yuste, L. C. Katz, “Control of postsynaptic calcium influx in developing neocortex by excitatory and inhibitory neurotransmitters,” Neuron 6, 333-344 (1991)
[2] D. Smetters, A. Majewska, R. Yuste, “Detecting Action Potentials in Neuronal Populations with Calcium Imaging,” METHODS: A Companion to Methods in Enzymology 18, 215-221 (1999).
[3] M. Kneen, J. Farinas, Y. Li, A. S. Verkman, “Green Fluorescent Protein as a Noninvasive Intracellular pH Indicator,” Biophy. J. 74, 1591-1599 (1998).
[4] S. Antic, D. Zecevic, “Optical signals from neurons with internally applied voltage-sensitive dyes,” J. Neurosci. 15, 1392-1405 (1995)
[5] A. H. Voie, D. H. Burns, F. A. Spelman, “Orthogonal-plane fluorescence optical sectioning: three- dimensional imaging of macroscopic biological specimens,” J. Microsc. 170, 229-236 (1993).
[6] D. Huber, M. Keller, D. Robert, “3D light scanning macrography,” J. Microsc. 203, 208-213 (2001).
[7] J. Huisken, J. Swoger, F. Del Bene, J. Wittbrodt, E. H. K. Stelzer, “Optical sectioning deep inside live embryos by selective plane illumination microscopy,” Science 305(5686), 1007-1009 (2004).
[8] T. F. Holekamp, D. Turaga, T. E. Holy, “Fast three-dimensional fluorescence imaging of activity in neural populations by objective-coupled planar illumination microscopy,” Neuron 57, 763-773 (2008).
[9] W. Göbel, B. M. Kampa, F. Helmchen, “Imaging cellular network dynamics in three dimensions using fast 3D laser scanning,” Nature Methods 4(1), 73-79 (2007).
[10] B. F. Grewe, D. Langer, H. Kasper, B. M. Kampa, F. Helmchen, “High-speed in vivo calcium imaging reveals neuronal network activity with near-millisecond precision,” Nat Methods 7(5), 399-405 (2010).
[11] A. Cheng, J. T. Gonçalves, P. Golshani, K. Arisaka, C. Portera-Cailliau, “Simultaneous two-photon calcium imaging at different depths with spatiotemporal multiplexing,” Nat Methods 8(2), 139-142 (2011).
[12] G. Katona, G. Szalay, P. Maák, A. Kaszás, M. Veress, D. Hillier, B. Chiovini, E. S. Vizi, B. Roska, B. Rózsa, “Fast two-photon in vivo imaging with three-dimensional random-access scanning in large tissue volumes,” Nat Methods 9(2), 201-208 (2012).
[13] F. Anselmi, C. Ventalon, A. Bègue, D. Ogden, V. Emiliani, “Three-dimensional imaging and photostimulation by remote-focusing and holographic light patterning,” Proc. Natl. Acad. of Sci. USA 108(49), 19504-19509 (2011).
[14] V. Nikolenko, K. E. Poskanzer, R. Yuste, “Two-photon photostimulation and imaging of neural circuits,” Nat. Methods 4(11), 943-950 (2007).
[15] V. Nikolenko, B. 0. Watson, R. Araya, A. Woodruff, D. S. Peterka, R. Yuste, “SLM Microscopy: Scanless two-photon imaging and photostimulation using spatial light modulators,” Front. Neural Circuits 2-5, 1-14 (2008).
[16] W. Denk, J. H. Strickler, W. W. Webb, “Two-photon laser scanning fluorescence microscopy,” Science 248(4951), 73-76 (1990).
[17] A. M. Packer, D. S. Peterka, J. J. Hirtz, R. Prakesh, K. Deisseroth, R. Yuste, “Two-photon optogenetics of dendritic spines and neural circuits,” Nature Methods 9, 1202-1205 (2012).
[18] J. W. Goodman, Introduction to Fourier Optics, 3rd Edition (Roberts & Company Publishers, 2004).
[19] E. J. Botcherby, R. Jugkaitis, M. J. Booth, T. Wilson, “An optical technique for remote focusing in microscopy,” Optics Communication 281, 880-887 (2008).
[20] J. W. Y. Lit, R. Tremblay, “Focal depth of a transmitting axicon,” JOSA 63(4), 445-449 (1973).
[21] G. Indebetouw, H. Bai, “Imaging with Fresnel zone pupil masks: extended depth of field,” Applied Optics 23(23), 4299-4302 (1984).
[22] H. P. Kao, A. S. Verkman, “Tracking of single fluorescent particles in three dimensions: use of cylindrical optics to encode particle position,” Biophys. J. 67(3), 1291-1300 (1994).
[23] E. R. Dowski, W. T. Cathey, “Extended depth of field through wave-front coding,” Appl. Opt. 34(11), 1859-1866 (1995).
[24] W. Chi, N. George, “Electronic imaging using a logarithmic asphere,” Optics Letters 26(12), 875-877 (2001).
[25] A. Greengard, Y. Y. Schechner, R. Piestun, “Depth from diffracted rotation,” Opt. Lett. 31(2), 181-183 (2006).
[26] S. Bagheri, P. E. X. Silveira, R. Narayanswamy, D. Pucci de Farias, “Analytical optical solution of the extension of the depth of field using cubic-phase wavefront coding. Part II. Design and optimization of the cubic phase,” JOSA A 25(5), 1064-1074 (2008).
[27] P. Polynkin, M. Kolesik, J. V. Moloney, G. A. Siviloglou, D. N. Christodoulides, “Curved Plasma Channel Generation Using Ultraintense Airy Beams,” Science 324, 229-232 (2009).
[28] D. M. Cottrell, J. A. Davis, T. R. Hedman, R. A. Lilly, “Multiple imaging phase-encoded optical elements written as programmable spatial light modulators,” Appl. Opt. 34, 3077-3086 (1990) (Yuste & Katz).
[29] G. J. Swanson, “Binary Optics Technology: The Theory and Design of Multi-level Diffractive Optical Elements,” MIT/Lincoln Laboratories Technical Report 854 (1989).
[30] Z. Zhang, G. Lu, F. Yu, “Simple method for measuring phase modulation in liquid crystal television,” Opt. Eng. 33, 3018-3022 (1994).
[31] R. Piestun, Y. Y. Schechner, J. Shamir, “Propagation-invariant wave fields with finite energy,” JOSA A 17(2), 892-902 (2000).
[32] P. Kner, J. W. Sedat, D. A. Agard, Z. Kan, “High-resolution wide-field microscopy with adaptive optics for spherical aberration correction and motionless focusing,” J. Microscopy 237, 136-147 (2010).

What is claimed is:

1. A non-transitory computer-accessible medium having stored thereon computer-executable instructions for generating at least one image of at least one portion of a sample, wherein, when a computer hardware arrangement executes the instructions, the computer arrangement is configured to perform procedures comprising:
receiving information related to at least one electro-magnetic radiation that was modified by an optical addressing arrangement, after being previously modified by the at least one portion of the sample, wherein the at least one portion of the sample is specifically targeted by at least one of a user or a computer instruction of the computer hardware arrangement by use of the optical addressing arrangement; and
generating the at least one image based on the information.

2. The non-transitory computer accessible medium of claim 1, wherein the optical addressing arrangement is a wavefront modification device.

3. The non-transitory computer accessible medium of claim 1, wherein the optical addressing arrangement is structured to modulate at least one of a phase or an amplitude of the at least one electro-magnetic radiation.

4. The non-transitory computer accessible medium of claim 1, wherein, the at least one electro-magnetic radiation has a definitive three dimensional structure when at least one electro-magnetic radiation is provided from the diffraction arrangement.

5. The non-transitory computer accessible medium of claim 4, wherein the structure is based at least in part on the at least one portion of the sample.

6. The non-transitory computer accessible medium of claim 1, wherein, upon exiting from an imaging system, the at least one electro-magnetic radiation is axially invariant.

7. The non-transitory computer accessible medium of claim 1, wherein the at least one electro-magnetic radiation at least one of (i) excludes a defocus blur or (ii) has a shape of a sheet when the at least one electro-magnetic radiation is in the at least one portion of the sample.

8. (canceled)

9. The non-transitory computer accessible medium of claim 1, wherein the at least one electro-magnetic radiation is a non-ambient light.

10. The non-transitory computer accessible medium of claim 1, wherein, upon exiting from the sample, the at least one electro-magnetic radiation is substantially lossless.

11. The non-transitory computer accessible medium of paragraph 1, further comprising at least one of (i) a spatial light modulation arrangement generating the information using at least one three dimensional illumination pattern, (ii) a two-photon light source which generates a source radiation being provided to the sample, the source radiation being related to the at least one electro-magnetic radiation, or (iii) a source arrangement generating the at least one electro-magnetic radiation by illuminating the sample with a source radiation.

12-13. (canceled)

14. The non-transitory computer accessible medium of claim 11, wherein the source arrangement illuminates the sample using a non-linear excitation radiation.

15. The non-transitory computer accessible medium of paragraph 11, wherein the illumination is at least one of (i) dynamic, (ii) temporally controlled, or (iii) spatially controlled.

16-17. (canceled)

18. The non-transitory computer accessible medium of claim 11, wherein the source arrangement illuminates the sample based on a priori knowledge of the sample.

19. The non-transitory computer accessible medium of claim 18, wherein the a priori knowledge includes at least one of (i) particular spots of the sample for the illumination, or (ii) a number of spots on the sample for the illumination.

20. The non-transitory computer accessible medium of claim 18, wherein the a priori knowledge is based on a previous illumination of the sample.

21. The non-transitory computer accessible medium according to claim 1, wherein the optical addressing arrangement includes a diffraction arrangement.

22. A system for generating at least one image of at least one portion of a sample, comprising:
a computer hardware arrangement which is configured to
a. receive information related to at least one electro-magnetic radiation that was modified by a dynamically configurable diffraction arrangement, after being previously modified by the at least one portion of the sample, wherein at least one of the at least portion of the sample is specifically targeted by at least one of a user or a computer instruction of the computer hardware arrangement by use of the diffraction arrangement, and
b. generating the at least one image based on the information.

23. A method for generating at least one image of at least one portion of a sample, wherein, when a computer hardware arrangement executes the instructions, comprising:
receiving information related to at least one electro-magnetic radiation that was modified by a diffraction arrangement, after being previously modified by the at least one portion of the sample, wherein at least one of the at least portion of the sample is specifically targeted by at least one of a user or a computer instruction of the computer hardware arrangement by use of the diffraction arrangement; and
generating the at least one image based on the information.

24. A system for generating at least one image of at least one portion of a sample, comprising:
a source arrangement configured to provide at least one electromagnetic radiation;
a spatial light modulation arrangement configured to receive at least one electro-magnetic radiation from the source, and generate an illumination pattern on the sample;
a wavefront modification arrangement configured to receive a return radiation from the sample that is based on the illumination pattern and provides a further radiation; and
an imaging arrangement configured to generate the at least one image based on the further radiation received from the wavefront modification arrangement.

25. The system of claim 24, wherein the sample is biological.

26. The system of claim 24, wherein the wavefront modification arrangement at least one of (i) controls a depth of the return radiation, (ii) is fixed and non-movable within the system, or (iii) is configured to increase information regarding a size of a volume of the sample.

27-28. (canceled)

29. The system of claim 26, wherein a performance by the imaging arrangement is invariant.

30. The system of claim 24, further comprising a processing arrangement configured to digitally post-process the at least one image to a near-optimal performance.
